(19) United States
(12) Patent Application Publication
(10) Pub. No.: US 2012/0285570 A1
(43) Pub. Date: Nov. 15, 2012

(54) PIPE JOINT CAPABLE OF ABSORBING WATER HAMMER SHOCK

(76) Inventor: Fu-Chung TSAI, Taichung (TW)

(21) Appl. No.: 13/103,229

(22) Filed: May 9, 2011

(51) Int. Cl. F16L 55/04

(52) U.S. Cl. 138/30

(57) ABSTRACT

A pipe joint, capable of absorbing water hammer shock, includes a tubular body, an elastic gasket, an inlet conduit and an outlet conduit. The tubular body has a passageway therethrough in which the elastic gasket is disposed. The elastic gasket divides the passageway of the tubular body into a first room and a second room and defines therein a plurality of holes each communicating with the first and second rooms. The inlet conduit is joined to one end of the tubular body and has a port in fluid communication with the first room of the tubular body. And, the outlet conduit is joined to the other end of the tubular body and has a port in fluid communication with the second room of the tubular body.

### BACKGROUND OF INVENTION

1. Field of Invention

The present invention relates to a pipe joint and pertains particularly to a pipe joint capable of protecting pipes from damage due to excessive internal pressure, such as rapid pressure surges and water hammer.

2. Related Prior Art

Water hammer or hydraulic shock commonly occurs when a valve is closed suddenly at an end of a pipeline system, and a pressure wave propagates in the pipe. This pressure wave can cause major problems, from noise and vibration to pipe collapse.

Accordingly, systems have been developed to reduce or eliminate the effects of water hammer. In some systems, it has been proposed to provide a shock absorber (or called a water hammer arrestor) that can be installed between the water pipe and the machine to prevent such water hammer damage. This arrangement, however, requires extra space outside the pipe for accommodation of the water hammer arrestor and is relatively expensive.

It is desire to provide a new type of pipe joint that is able to effectively absorb water hammer shock.

### SUMMARY OF INVENTION

Broadly stated, the present invention is directed to a new type of pipe joint that is able to absorb water hammer shock. The pipe joint includes a tubular body, an elastic gasket, an inlet conduit and an outlet conduit. The tubular body has a passageway therethrough in which the elastic gasket is disposed. The elastic gasket divides the passageway of the tubular body into a first room and a second room and defines therein a plurality of holes each communicating with the first and second rooms. The inlet conduit is joined to one end of the tubular body and has a port in fluid communication with the first room of the tubular body. Likewise, the outlet conduit is joined to the other end of the tubular body and has a port in fluid communication with the second room of the tubular body.

Preferably, the inlet conduit has an end portion having an external thread adapted to engage an internal thread of the end of the tubular body. And, the tubular body has an annular stop extending inward from an inner wall thereof So, the elastic gasket can be sandwiched and properly positioned between the annular stop of the tubular body and the end portion of the inlet conduit.

The construction of pipe joint as described above includes the unique elastic gasket within the tubular body to buffer against the water hammer and is thus far from conventional and relatively inexpensive.

Further features and advantages of the present invention will be appreciated by review of the following detailed description of the invention.

### BRIEF DESCRIPTION OF DRAWINGS

Practical embodiments of the invention are shown in the accompanying drawing, wherein:

FIG. 1 is an exploded view of a pipe joint in accordance with a first embodiment of the invention;

FIG. 2 is a perspective view of the pipe joint of FIG. 1 with a screw type pipe coupling;

FIG. 3 is a perspective view of another pipe joint with a quick pipe coupling;

FIG. 4 is a perspective view of a water treatment system in which the pipe joint of FIG. 1 is employed to advantage;

FIG. 5 is a cross section of the pipe joint of FIG. 1, showing the pipe joint is in a normal position where water flows therethrough;

FIG. 6 is a view similar to FIG. 5, showing that an elastic gasket of the pipe joint acts as a buffer against pressure surges;

FIG. 7 is a cross-sectional view of a pipe joint in accordance with a second embodiment of the invention, showing the pipe joint is in a normal position where water flows therethrough; and

FIG. 8 is a view similar to FIG. 7, showing that an elastic gasket of the pipe joint acts as a buffer against pressure surges.

### DETAILED DESCRIPTION OF EMBODIMENTS

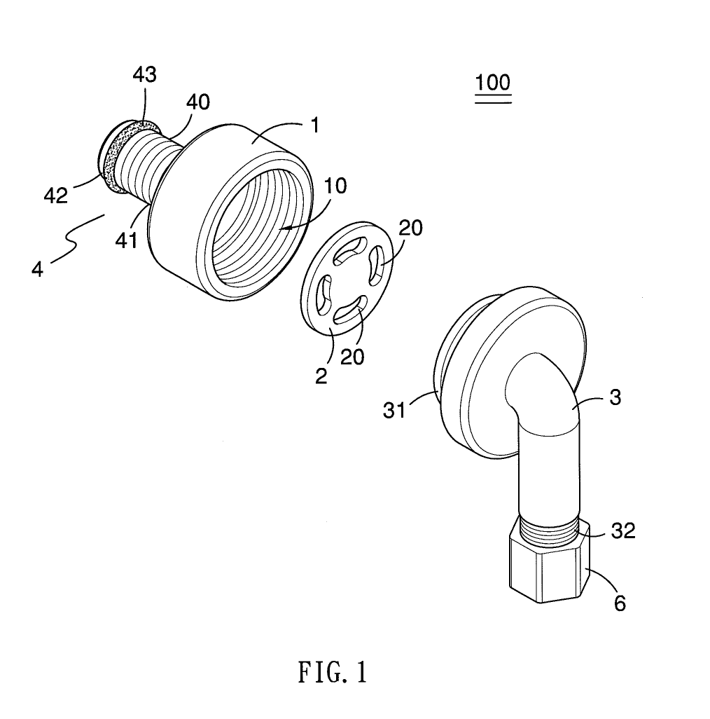

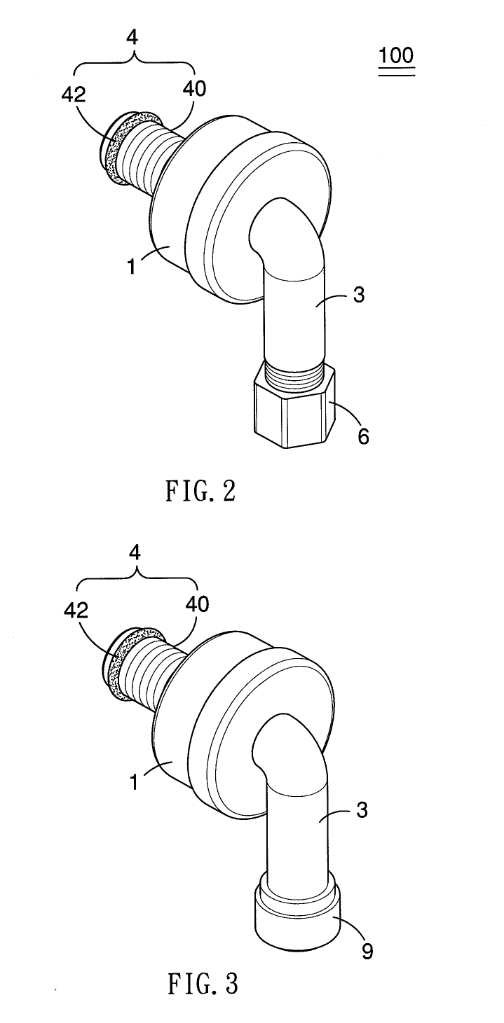

With reference to FIGS. 1-6, there is shown an illustration of a pipe joint 100 in accordance with a first embodiment of the present invention. The pipe joint 100 includes a tubular body 1, an elastic gasket 2, an inlet conduit 3, an outlet conduit 4 and a pipe coupling which may be a screw type pipe coupling 6, as shown in FIG. 2, or a quick pipe coupling 9, as shown in FIG. 3, for example.

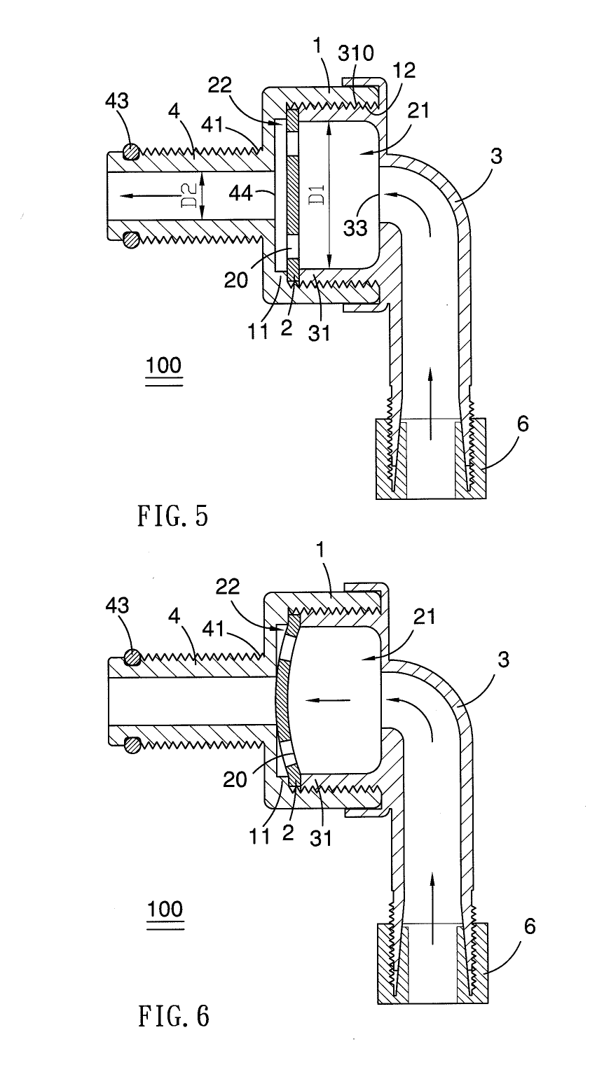

The tubular body 1 has an axial fluid flow passageway 10 therethrough and has one end joined with the elbow inlet conduit 3, and the other end with the outlet conduit 4. The elastic gasket 2 is disposed in the passageway 10 of the tubular body 1 and divides the passageway 10 of the tubular body 1 into a first room 21 and a second room 22, as shown in FIG. 5. Further, the elastic gasket 2 defines therein a plurality of holes 20 each communicating with the first and second rooms 21, 22 in the tubular body 1. Preferably, the holes 20 of the elastic gasket 2 are defined in a peripheral edge of the elastic gasket 2, as shown in FIG. 1. The inlet conduit 3 has a port 33 in fluid communication with the first room 21 of the tubular body 1, and the outlet conduit 4 has a port 44 in fluid communication with the second room 22 of the tubular body 1.

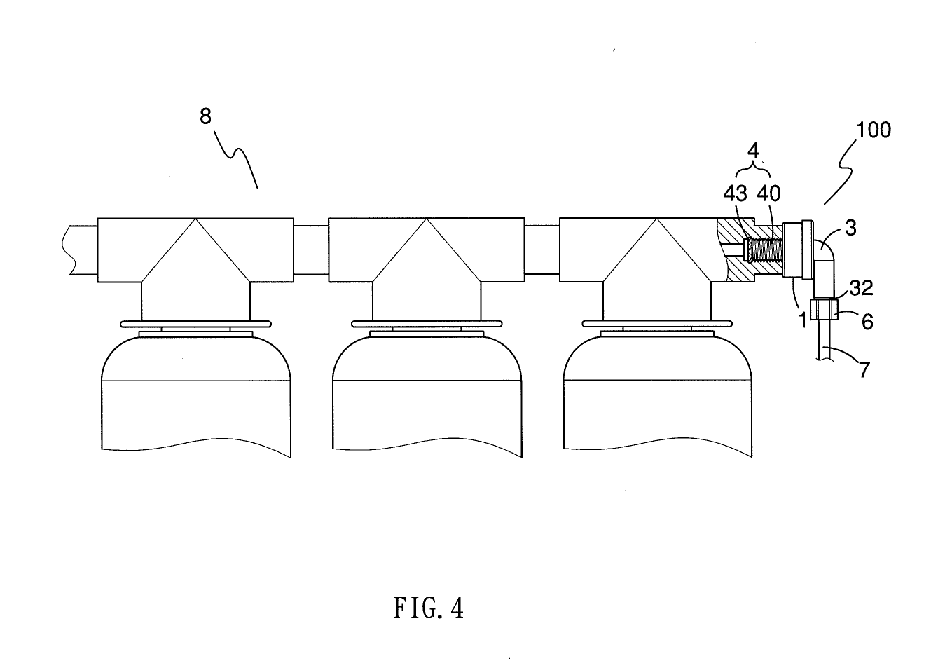

FIG. 4 illustrates a water treatment system, such as a reverse osmosis water purifier, in which the pipe joint 100 is employed to advantage. The water treatment system is set with three in-line filter cartridges 8 to which the pipe joint 100 is coupled. The tap water pipeline 7 is connected with the inlet conduit 3 of the pipe joint 100 via the pipe coupling 6.

Specifically, the outlet conduit 4 has one end 41 connected with the tubular body 1 and the other end 42 to be joined with the adjacent one of the filter cartridges 8. An O-ring 43 may be introduced on the other end 42 of the outlet conduit 4 to seal against movement of fluid. As shown in FIG. 5, the tubular body 1 and the outlet conduit 4 are of one-piece construction, and the tubular body 1 has a diameter D1 greater than that D2 of the outlet conduit 4 to create a buffer space for water hammer. The inlet conduit 3 is, but not limited to, in the form of elbow and has an enlarged end portion 31 having an external thread 310 engaged with an internal thread 12 of the tubular body 1. As shown in FIG. 4, the inlet conduit 3 has the other end portion 32 in thread engagement with the pipe coupling 6 to which the tap water pipeline 7 is connected.

As shown in FIG. 5, the tubular body 1 further has an annular stop 11 extending inward from an inner wall thereof The elastic gasket 2 is sandwiched between the annular stop 11 of the tubular body 1 and the end portion 31 of the inlet conduit 3. Preferably, the end portion 31 of the inlet conduit 3 is formed thereon with a plurality bumps (not shown) to tightly press against the elastic socket 2. In this manner, the elastic gasket 2 can be well positioned within the tubular body 1.

FIG. 5 illustrates that water normally flows through the pipe joint 100. If the water treatment system suddenly shuts off the water flow, the elastic gasket 2 within the tubular body 1 will be deformed as depicted in FIG .6 to buffer against the pressure surges. Afterward, the elastic gasket 2 can be restored by itself back to its original state, as shown in FIG. 5. Thus, the outlet conduit 4 as well as the filter cartridges 8 is protected against the water hammer.

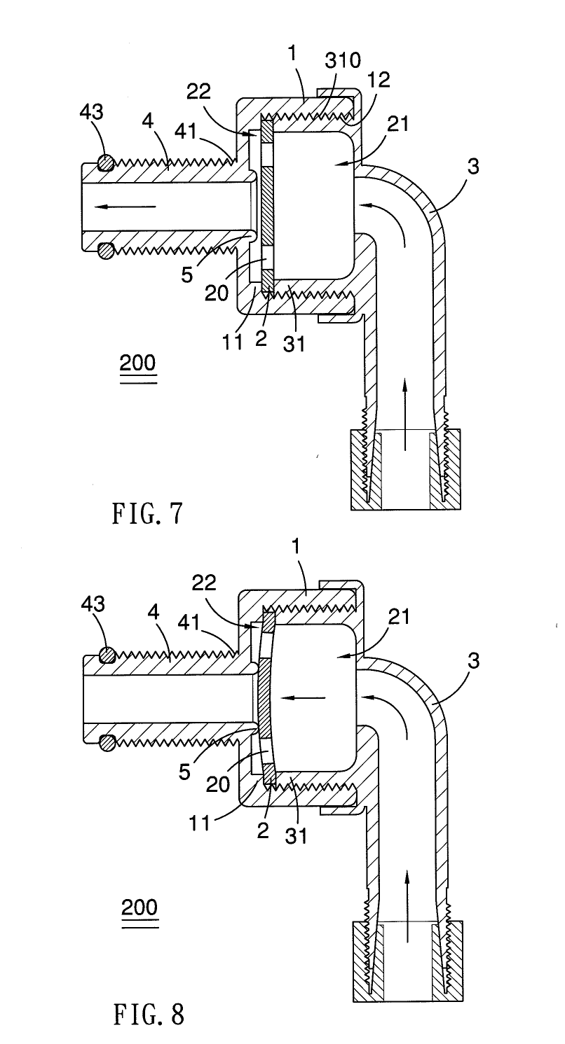

With reference to FIGS. 7 and 8, a pipe joint 200 in accordance with a second embodiment of the present invention is illustrated. Similar to the pipe joint 100 of FIG. 5, the pipe joint 200 of the second embodiment comprises generally a tubular body 1, an elastic gasket 2, an inlet conduit 3, an outlet conduit 4 and a pipe coupling 6, except that the end portion 41 of the outlet conduit 4 is formed thereon with an annular support ring 5 surrounding a passageway of the outlet conduit 4 and projecting into the second room 22 of the tubular body 1. Further, the support ring 5 is spaced apart from the elastic gasket 2 to permit water flow from the tubular body 1 into the outlet conduit 4, as shown in FIG. 7. Preferably, the holes 20 of the elastic gasket 2 are defined in the peripheral edge of the elastic gasket 2 corresponding to a zone between the support ring 5 of the outlet conduit 4 and the annular stop 11 of the tubular body 1. In this manner, when the water flow is suddenly shut off, the support ring 5 provides suitable strength and support for the elastic gasket 2 to buffer against the water hammer, as shown in FIG. 8.

It will be appreciated that although a particular embodiment of the invention has been shown and described, modifications may be made. It is intended in the claims to cover such modifications which come within the spirit and scope of the invention.

The invention claimed is:

1. A pipe joint comprising:
a tubular body having a passageway therethrough;
an elastic gasket disposed in the passageway of the tubular body, dividing the passageway of the tubular body into a first room and a second room and defining therein a plurality of holes each communicating with the first and second rooms;
an inlet conduit joined to one end of the tubular body and having a port in fluid communication with the first room of the tubular body; and
an outlet conduit joined to the other end of the tubular body and having a port in fluid communication with the second room of the tubular body.

2. The pipe joint of claim 1, wherein the inlet conduit has an end portion having an external thread adapted to engage an internal thread of the end of the tubular body; the tubular body further has an annular stop extending inward from an inner wall thereof; and the elastic gasket is sandwiched between the annular stop of the tubular body and the end portion of the inlet conduit.

3. The pipe joint of claim 2, wherein the tubular body and the outlet conduit are of one-piece construction, and the tubular body has a diameter greater than that of the outlet conduit.

4. The pipe joint of claim 3, wherein the inlet conduit is in the form of elbow.

5. The pipe joint of claim 2, wherein the outlet conduit has an end portion connected with the other end of the tubular body; the end portion of the outlet conduit is formed thereon with an annular support ring surrounding a passageway of the outlet conduit, projecting into the second room of the tubular body and being spaced apart from the elastic gasket.

6. The pipe joint of claim 5, wherein the holes of the elastic gasket are defined in a peripheral edge of the elastic gasket corresponding to a zone between the support ring of the outlet conduit and the annular stop of the tubular body.

7. The pipe joint of claim 1, wherein the tubular body and the outlet conduit are of one-piece construction, and the tubular body has a diameter greater than that of the outlet conduit.

8. The pipe joint of claim 7, wherein the outlet conduit has an end portion connected with the other end of the tubular body; the end portion of the outlet conduit is formed thereon with an annular support ring surrounding a passageway of the outlet conduit, projecting into the second room of the tubular body and being spaced apart from the elastic gasket.

9. The pipe joint of claim 8, wherein the holes of the elastic gasket are defined in a peripheral edge of the elastic gasket corresponding to a zone between the support ring of the outlet conduit and the annular stop of the tubular body.
